(19) United States
(12) Patent Application Publication
(10) Pub. No.: US 2011/0045147 A1
(43) Pub. Date: Feb. 24, 2011

(54) PROTEIN-BASED OIL ENCAPSULATES

(75) Inventors: Aart Cornelis Alting, Ede (NL); Theodorus Arnoldus Gerardus Floris, Arnhem (NL); Fanny Chantal Jacqueline Weinbreck, Amersfoort (NL); Jeroen Grandia, Ede (NL); Freddie Van De Velde, Ede (NL)

Correspondence Address: FOLEY AND LARDNER LLP;SUITE 500, 3000 K STREET NW, WASHINGTON, DC, 20007, US

(73) Assignee: NIZO Food Research B.V.

(21) Appl. No.: 12/745,466

(22) PCT Filed: Dec. 1, 2008
(86) PCT No.: PCT/NL08/00264

§ 371 Date: Nov. 1, 2010

(30) Foreign Application Priority Data
Nov. 29, 2007 (EP) 07121901.8

(51) Int. Cl. A23D 7/00; A23D 7/04

(52) U.S. Cl. 426/98; 426/605; 426/271; 426/590; 426/442

(57) ABSTRACT

The invention provides an encapsulate comprising a protein-based encapsulation matrix that envelops one or more oil droplets containing at least 3 wt. % of polyunsaturated fatty acids (PUFAs) by weight of oil; said encapsulate having a mass weighted average diameter in the range of 0.5-5000 μm, wherein the protein-based encapsulation matrix contains at least 10 wt. % of a protein that has been cross-linked by means disulfide cross-links, said protein-based matrix further being characterized in that:
i. less than 75 wt. %, preferably less than 40 wt. % of the protein contained in the protein-based matrix can be dissolved when 75 mg of the encapsulate is dispersed in 50 ml distilled water having a temperature of 5° C. at any pH within the range of 3.0-7.0;
ii. the weight percentage of the protein that can be dissolved is at least a factor 1.3 higher when in the procedure under i) the distilled water is replaced by an aqueous solution of 2 wt. % dithiothreitol (DTT).

The encapsulate according to the present exhibits very high oxidative stability and can be produced via a robust and relatively simple manufacturing process.

The invention also provides a process for the manufacture of the aforementioned encapsulate.

### TECHNICAL FIELD OF THE INVENTION

The present invention relates to protein-based oil encapsulates, more particularly to encapsulates that comprise a protein-based encapsulation matrix holding one or more oil droplets containing easily oxidizable polyunsaturated fatty acids. The oil contained in the encapsulates of the present invention is protected very effectively against the oxidative effect of atmospheric oxygen.

### BACKGROUND OF THE INVENTION

Encapsulation techniques have been developed to protect components against the detrimental effects of e.g. oxygen, moisture, heat, light or chemical reactions and further to control the release of encapsulated components under conditions of use. Acceptable encapsulating agents must be safe and non-hazardous to the consumer's health. For food products it should have a bland or no flavor. Suitable encapsulation agents for food applications include natural gums, carbohydrates, fats and waxes and some proteins. Whereas gum Arabic is one of the most widely used encapsulation agent in food applications the use of proteins is limited. The main protein that has been evaluated for encapsulation is gelatin. Gelatin has been successfully applied as encapsulation agent in the pharmaceutical industry. However, due to the high viscosity of aqueous gelatin solutions, gelatin has limited use in spray-drying processes.

U.S. Pat. No. 5,601,760 describes a method for microencapsulation of a volatile or a non-volatile core material in an encapsulation agent consisting essentially of a whey protein. It is described that whey protein isolate and whey protein concentrate, optionally in combination with milk-derived or non-milk derived carbohydrates, and also β-lactoglobulin and mixtures of β-lactoglobulin and α-lactalbumin were used in a spray-drying encapsulation process. The resulting encapsulates were said to protect the core against deterioration by oxygen or from detrimental of other compounds or materials, to limit the evaporation or losses of volatile core materials and to release the core upon full hydration reconstitution. One example describes encapsulation of anhydrous milk fat in whey protein isolate that has been heated at 80° C. for 30 minutes. This treatment results in denaturation of whey proteins.

EP-A 1 042 960 describes a cappuccino creamer with advantageous foaming properties. The creamer is prepared by spray-drying a slurry that includes as essential constituents protein, lipid and carrier. The lipid includes dairy fats and vegetable oils. Suitable carriers include gum Arabic and water soluble carbohydrates such as maltodextrin and lactose. The protein is partly denatured whey protein (concentrate or isolate). The product is said to contain buoyant, hydrated, insoluble, non-colloidal, irregularly shaped whey protein particles of approximately 10-200 microns in size, with an average particle size of about 60 microns. To provide coffee whitening and creamy mouth feel a significant amount of encapsulated fat has to be included.

US 2004/0017017 describes a method for encapsulating an encapsulant comprising admixing an oil component which comprises an encapsulant, with an aqueous component, and a film-forming component to form an emulsion, subjecting the emulsion to homogenization to obtain an oil-in-water emulsion, comprising oil droplets wherein the oil droplets comprise the encapsulant and the film-forming component surrounds the oil droplets, reducing the water content of the emulsion so that the film-forming component forms a film around the oil droplets and encapsulates said encapsulant, and applying a protective coating on the film-coated oil droplets to obtain pellets and to prevent diffusion of said oil component to the surface of the pellets. The examples describe a process in which a solution comprising water and 9.5 wt. % whey protein is denatured by heating to 80-90° C. for 30 minutes. Subsequently, cysteine, glycerol and omega-3 fish oil are added to produce an emulsion. After homogenisation the emulsion is combined in an extruder with a dry feed of durum wheat flour to produce pellets containing 25 wt. % water, 13.8 wt. % fish oil, 2.0 wt. % whey protein isolate, 0.3 wt. % glycerol and 58.9 wt. % of the durum wheat flour. Next, the pellets are dried and coated with a mixture of denatured whey protein isolate and sucrose in a pan coater.

The encapsulation techniques of the prior art suffer from the drawback that encapsulated oils that are easily oxidized are not effectively prevented against oxidation by atmospheric oxygen and/or that the process of encapsulation is very laborious, e.g. because sufficient oxidative stability can only be realized by providing the encapsulate with one or more impermeable coatings.

It is an object of the invention to provide protein-based oil encapsulates that exhibit high oxidative stability and that can be produced via a robust and relatively simple manufacturing process.

### SUMMARY OF THE INVENTION

The inventors have discovered that the aforementioned objective can be realized by encapsulating an oxidation sensitive oil, notably an oil containing substantial levels of easily oxidizable polyunsaturated fatty acids, in a matrix of protein that has been cross-linked by means of disulfide cross-links. It was found that these disulfide cross-linkages enhance the ability of the protein-based matrix to protect the encapsulated oil against atmospheric oxygen. In particular if a protein is utilized that is capable of forming a plurality of disulfide cross-links per molecule, it is possible to produce a cross-linked protein-based matrix that is virtually impermeable for oxygen. Protein matrices that exhibit a high degree of disulfide cross-linking are further characterized by a very poor water solubility. Thus, encapsulates containing a disulfide cross-linked protein-based matrix in accordance with the present invention continue to effectively protect the oil component against oxidation even if they are exposed to moisture or if they are applied in products containing water.

Proteins that can suitably be cross-linked by disulfide links include proteins that contain amino acid residues with a thiol-group, notably cystein. Provided these cystein groups have been ‘activated’ in a suitable manner, cystein groups in different protein molecules can react with each other, thereby linking these protein molecules by a disulfide cross-link.

Not only cystein residues that have free thiol groups can participate in these cross-linking reactions, but also cystein residues that together form a disulfide bridge can react with a thiol group under the formation of a new disulfide bridge and the release of another free thiol group. This is why β-lactoglobulin can suitably be used as a cross-linkable protein even though this protein normally contains two pairs of cystein residues that form disulfide bridges and only one cystein residue that contains a free thiol group. Examples of proteins that are capable of forming disulfide cross-links include whey proteins, egg proteins, soy proteins, lupine proteins, rice proteins, pea proteins and wheat proteins.

The disulfide cross-linked protein-based matrix in the present encapsulates can, for example, be formed by a process that involves the following steps:
providing an aqueous solution of a protein that is capable of forming disulfide cross-links;
subjecting the aqueous solution to a heat treatment to produce an aqueous suspension of activated protein aggregates; and
drying said aqueous suspension whilst supplying sufficient heat to cross-link the activated aggregates by means of disulfide links.

The activation step in the aforementioned process is a special form of protein denaturation and is crucial for the formation of disulphide cross-links between activated protein aggregates during the drying step. In the present method the activated protein aggregates are formed by irreversible denaturation of dissolved protein molecules, resulting in exposure of thiol groups that have the ability and accessibility to form disulfide bridges. In the course of the activation process, the reactive thiol groups of denatured protein molecules react together to form disulfide bridges. Thus, aggregates comprising a multitude of cross-linked protein molecules are formed. In the present method it is crucial that these aggregates retain reactive thiol groups as these reactive thiol groups are required for the cross-linking of the activated aggregates.

Activated protein aggregates can be prepared by various methods, such as heating, high pressure treatment etc. The resulting protein reactivity is determined by the overall treatment conditions (shear, protein concentration, type of protein, protein composition, type and concentration of salts, pH, other ingredients such as sugars and polysaccharides, fats). Typically, the activated aggregates used in the preparation of the present encapsulates exhibit a reactivity of at least 5 μmol thiol groups per gram of protein, as determined in the Ellman's assay (Ellman, G. L. Tissue sulfhydryl groups. Arch. Biochem. Biophys. 1959, 82, 70-77).

The protein-based oil encapsulates of the present invention can be produced through different manufacturing processes that all have in common that first a suspension is formed of activated protein aggregates and the dispersed oil component. Next, the activated protein aggregates are cross-linked in such a way that the oil becomes trapped within the cross-linked protein-based matrix. As described above, the cross-linking may be brought about by drying the aforementioned suspension under suitable conditions.

The inventors have discovered that in a suspension comprising a dispersed oil phase and activated protein aggregates, the protein aggregates will spontaneously form a layer around the oil droplets. Thus, it is possible to encapsulate the oil droplets in situ by cross-linking the protein aggregates in the interfacial layer. This cross-linking can be achieved by subjecting the suspension to a heat treatment or ultra high pressure. Alternatively, cross-linking may be brought about by contacting the activated aggregates in the interfacial layer with an oxidizing agent, e.g. copper chloride or glutathione peroxidase.

### DETAILED DESCRIPTION OF THE INVENTION

Accordingly, one aspect of the invention relates to an encapsulate comprising a protein-based encapsulation matrix that envelops one or more oil droplets containing at least 3 wt. % of polyunsaturated fatty acids (PUFAs) by weight of oil; said encapsulate having a mass weighted average diameter in the range of 0.5-5000 μm, wherein the protein-based encapsulation matrix contains at least 10 wt. % of a protein that has been cross-linked by means disulfide cross-links, said protein-based matrix further being characterized in that:
i. less than 75 wt. %, preferably less than 40 wt. % of the protein contained in the protein-based matrix can be dissolved when 75 mg of the encapsulate is dispersed in 50 ml distilled water having a temperature of 5° C. at any pH within the range of 3.0-7.0;
ii. the weight percentage of the protein that can be dissolved is at least a factor 1.3 higher when in the procedure under i) the distilled water is replaced by an aqueous solution of 2 wt. % dithiothreitol (DTT).

In the above mentioned solubility tests and the solubility tests described elsewhere in this document the pH of the distilled water or the DTT solution is adjusted with the help of HCl and solubility is measured 16 hours after the encapsulate was dispersed in the liquid. During this period the mixture is continuously gently stirred in order to prevent ‘clumping’ of the encapsulate particles. In both the solubility test i) and ii) pH is adjusted to achieve maximum protein solubility within the pH range of 3.0-7.0.

The poor solubility of the cross-linked protein-based matrix in distilled water is indicative for the high level of cross-linking, which is a prerequisite for the high oxidative stability of the present oil encapsulates. Without the disulfide cross-links the protein-based matrix of the present encapsulate would exhibit a much higher water solubility. This can be demonstrated by repeating the solubility test i) using an aqueous dithiothreitol (DTT) solution instead of distilled water. Since DTT reduces disulfide bonds and maintains the monothiols in a reduced state, the difference in solubility observed in the solubility tests with the DTT solution and distilled water is indicative of the level of disulfide cross-linking

The term “encapsulate” as used herein refers to a particulate material. The individual particles within the encapsulate can consist of clearly identifiable discrete particles, but they can also consists, for instance, of a cluster of (micro-)particles, e.g. as a result of agglomeration.

The term “protein” as used herein refers to a polymer made of amino acids arranged in a chain and joined together by peptide bonds between the carboxyl and amino groups of adjacent amino acid residues. Typically, the protein contains at least 10 amino acid residues. The protein employed in accordance with the present invention can be, for instance, an intact naturally occurring protein, a protein hydrolysate or a synthesised protein.

The term “oil” as used herein encompasses any lipid substance that contains one or more fatty acid residues. Thus, the term oil encompasses, for instance, triglycerides, diglycerides, monoglycerides, free fatty acids and phospholipids. The oil employed in accordance with the present invention can be a solid, a liquid or a mixture of both.

The term “fatty acid” as used herein encompasses free fatty acids as well as fatty acid residues.

Whenever reference is made herein to a weight percentage of fatty acids, this weight percentage includes free fatty acids as well as fatty acid residues (e.g. fatty acid residues contained in triglycerides).

The term “polyunsaturated fatty acid” (PUFA) as used herein encompasses any fatty acid containing 2 or more double bonds in the carbon chain.

The term “comprising” is to be interpreted as specifying the presence of the stated parts, steps or components, but does not exclude the presence of one or more additional parts, steps or components. In addition, reference to an element by the indefinite article “a” or “an” does not exclude the possibility that more than one of the element is present, unless the context clearly requires that there be one and only one of the elements. The indefinite article “a” or “an” thus usually means “at least one”.

The present invention enables the preparation of oxidation stable encapsulates containing substantial levels of oil. Preferably, the oil droplets in the encapsulate represent at least 5 wt. %, more preferably at least 10 wt. %, even more preferably at least 20 wt. % and most preferably at least 35 wt. % of the encapsulate. Typically, the oil droplets represent not more than 80 wt. % of the encapsulate. Here the weight percentage of oil droplets is calculated on the encapsulate exclusive any coating layers that may have been applied onto the (core) encapsulate.

The high payload of oil that can advantageously be achieved in the encapsulates of the present invention is reflected in a high oil to protein ratio. Typically, the oil in the oil droplets and the protein in the protein-based encapsulation matrix are contained in the encapsulate in a weight ratio oil:protein of 1:8 to 200:1, preferably in a weight ratio of 1:4 to 10:1.

The oil droplets in the encapsulate preferably contain at least 50 wt. %, more preferably at least 70 wt. % and most preferably at least 80 wt. % of a lipid material selected from the group consisting of triglycerides, diglycerides and mixtures thereof. Preferably, the oil droplets consist of an oil having a melting point of less than 40° C., more preferably of less than 30° C. and most preferably of less than 15° C.

PCT/NL2007/050233, which was not published prior to the filing date of the present application, contains examples in which sunflower oil is encapsulated by spray drying a pre-emulsion containing reactive whey protein aggregates and sunflower oil. In accordance with a preferred embodiment of the present invention the oil contained in the encapsulate contains less than 80% sunflower oil, preferably less than 50% sunflower oil by weight of the oil. Most preferably, the oil droplets do not contain sunflower oil.

The protein-based encapsulation matrix, besides cross-linked protein may suitably contain other matrix components, such as carbohydrates (e.g. fibers, inulin, maltodextrin, lactose, sucrose, glucose, galactose), hydrocolloids (e.g. gum Arabic, alginate, pectin, starch, xanthan gum, carrageenan, guar gum, locust bean gum, tara gum, gellan gum), polyols (e.g. glycerol, xylitol), plasticizers (e.g. glyceryl triacetate and/or di-(2-ethylhexyl)adipate) and non cross-linked protein (e.g. gelatin). Preferably, the protein-based encapsulation matrix contains at least 20 wt. %, even more preferably at least 40 wt. % and most preferably at least 60 wt. % of a protein that has been cross-linked by means disulfide cross-links

In order to prepare a protein-based encapsulation matrix that exhibits a high level of disulfide cross-linking it is advisable to employ a protein containing at least three cross-linkable groups. Accordingly, in a preferred embodiment the protein that has been cross-linked by disulfide cross-links in its native form comprises at least three cystein residues per molecule, even more preferably at least 4 and most preferably at least 5 cystein residues per molecule. The whey proteins β-lactoglobulin and α-lactoglobulin contain 5 and 8 cystein residues per molecule, respectively. Here the term “in native form” refers to the natural state of the protein in the material it is sourced from. The term “cystein residue” also encompasses cystein residues that are bound to other cystein residues by means of a disulfide bond.

In another embodiment the protein that has been cross-linked by disulfide cross-links in native form preferably comprises at least about 1 or even 2 cystein residues per 500, especially per 400 amino acids, more preferably at least 1 or even 2 cystein residues per 300 or 200 amino acids, even more preferably per 100, 30 or 20 amino acids. The average molecular weight of the protein is preferably at least 5, 10, 15, 20, 50, 100, 200, 250 or more kDa as determined by SDS-PAGE analysis.

In its native form, the protein that has been cross-linked by disulfide cross-links advantageously contains at least 30 amino acid residues, more preferably at least 50 amino acid residues and most preferably at least 60 amino acid residues.

Examples of proteins that are capable of forming disulfide cross-links and that can suitably be employed in the protein based matrix include whey proteins and plant proteins, such as wheat proteins, soybean proteins, pea proteins, lupine proteins, canola or oilseeds rape proteins, maize proteins, rice proteins, and many others. Similarly, animal proteins such as bovine serum albumin, one or more blood proteins, one or more egg proteins may be used. In addition, also certain microbial proteins such as one or more bacterial proteins and/or fungal proteins (including yeast proteins) can be used.

The protein in the protein-based matrix that has been cross-linked by disulfide cross-links is preferably selected from one or more of the group consisting of whey proteins, egg proteins, soy proteins, lupine proteins, rice proteins, pea proteins, wheat proteins and combinations thereof. Even more preferably, said cross-linked protein is selected from the group consisting of whey proteins, egg proteins, soy proteins and combinations thereof. Most preferably, the latter protein is a whey protein or a combination of whey proteins.

The encapsulates of the present invention contain a protein-based matrix that is made up of macromolecules consisting of a hundreds or thousands of protein molecules that have been cross-linked by disulfide bonds. According to a particularly preferred embodiment, the protein that has been cross-linked by disulfide cross-links exhibits a number weighted average degree of polymerisation of at least 500 more preferably of at least and most preferably of at least 1000. Here the degree of polymerisation equals the total number of protein molecules that are linked together in a single cross-linked macromolecule.

The advantageous properties of the present encapsulates are particularly pronounced in case the oil droplets contain high levels of PUFAs. Accordingly, in a preferred embodiment, these oil droplets contain at least 5 wt. % of PUFAs. Even more preferably, the oil droplets contain at least 10 wt. %, most preferably at least 20 wt. % of PUFAs.

Examples of PUFAs that can advantageously incorporated in the oil droplets of the present encapsulate include linoleic acid, linolenic acid, w3-unsaturated fatty acids, w6-unsaturated fatty acids and combinations thereof. According to a particularly preferred embodiment, the oil droplets contains at least 3 wt. %, more preferably at least 5 wt. % and most preferably at least 10 wt. % of one or more PUFAs selected from the group consisting of C₁₈-C₂₄ w3-fatty acids, C₁₈-C₂₄ w6-fatty acids and combinations thereof.

According to a particularly preferred embodiment, the PUFAs are selected from the group consisting of docosahexaenoic acid (DHA), eicosapentaenoic acid (EPA), arachidonic acid, gamma-linoleic acid, conjugated linoleic acid (CLA) and combinations thereof. Most preferably, the PUFAs are selected from the group consisting of DHA, EPA, CLA and combinations thereof.

The PUFA in the oil droplets of the present encapsulate may suitably be provided by a vegetable oil or a marine oil. Examples of such oils include fish oil, algae oil and linseed oil. Naturally, the present invention also encompasses encapsulates in which the oil droplets comprise a blend of a high PUFA oil and one or more other lipid components.

The encapsulates of the present invention typically have a mass weighted average diameter in the range of 0.5-1000 μm. Even more preferably the mass weighted average diameter of the present encapsulates is in the range of 1-500 μm, most preferably in the range of 1-100 μm. The present encapsulate can be prepared in the form of a granulate with a relatively large diameter by e.g. extrusion or alternatively by agglomerating an encapsulate with a smaller particle distribution. Encapsulates with a relatively small particle size can be obtained by means of e.g. spray drying. The particle size distribution of the encapsulate can suitably be determined in a manner well known to a skilled person using a set of sieves with different well-defined mesh sizes.

The present invention also encompasses encapsulates in which protein in the protein-based matrix has not only been cross-linked by disulfide bonds, but in which additional cross-linking mechanisms have been used to cross-link the protein molecules. Examples of alternative cross-linking techniques include the use of gluteraldehyde as cross-linking agent and the use of transglutaminase. Preferably, however, the protein in the present encapsulate has not been cross-linked in any other way than by disulfide cross-links.

The size of the oil droplets in the present encapsulate can vary within a wide range. Typically, the oil droplets in the encapsulate have a volume weighted average diameter in the range of 0.05-25 μm. More preferably, the volume weighted diameter of the oil droplets is within the range of 0.1-10 μm. Most preferably, said diameter is within the range of 0.2-5 μm. The volume weighted average diameter of the oil droplets is suitably determined by means of light scattering techniques.

The poor water solubility of the protein-based matrix of the present encapsulate is associated with the high level of disulfide cross-linking within said matrix. Without these cross-links the protein-based matrix normally has a much higher water solubility. Thus, according to a very preferred embodiment, the protein-based matrix is characterized in that more than 60 wt. %, more preferably more than 80 wt. % and most preferably at least 90 wt. % of the protein contained in the protein-based matrix dissolves in an aqueous solution of 2 wt. % DTT having a temperature of 25° C. and a pH in the range of 3.0-7.0.

As mentioned herein before, the protein-based oil encapsulates according to the present invention exhibit the special property that the protein contained in the protein-based matrix exhibits very poor water solubility as a result of the disulfide cross-linking. This poor water solubility is also apparent within a broad pH range at near ambient conditions. Consequently, in a preferred embodiment, the protein-based matrix is characterized in that less than 70 wt. %, more preferably less than 40 wt. % and most preferably less than 25 wt. % of the protein contained in the protein-based matrix can be dissolved when 75 mg of the encapsulate is dispersed in 50 ml distilled water having a temperature of 25° C. at any pH within the range of 3.0-7.0. Preferably, the weight percentage of the protein that can be dissolved is at least a factor 1.3 higher when in the aforementioned procedure the distilled water is replaced by an aqueous solution of 2 wt. % DTT. According to a particularly preferred embodiment, the protein-based matrix is characterised in that:
i. less than 40 wt. %, more preferably less than 25 wt. % of the protein contained in the protein-based matrix can be dissolved when 75 mg of the encapsulate is dispersed in 50 ml distilled water having a temperature of 25° C. at any pH within the range of 3.0-7.0;
ii. the weight percentage of the protein that can be dissolved is at least a factor 2 higher when in the aforementioned procedure the distilled water is replaced by an aqueous solution of 2 wt. % DTT.

According to yet another preferred embodiment, the protein-based matrix is characterized in that less than 40 wt. %, more preferably less than 25 wt. % of the protein-based matrix can be dissolved when 75 mg of the encapsulate is dispersed in 50 ml distilled water having a temperature of 25° C. at any pH within the range of 1.0-8.0.

According to a particularly preferred embodiment, the protein-based matrix is characterised in that:
i. less than 40 wt. %, more preferably less than 25 wt. % of the protein contained in the protein-based matrix can be dissolved when 75 mg of the encapsulate is dispersed in 50 ml distilled water having a temperature of 25° C. at any pH within the range of 1.0-8.0;
ii. the weight percentage of the protein that can be dissolved is at least a factor 2 higher when in the aforementioned procedure the distilled water is replaced by an aqueous solution of 2 wt. % DTT.

In the present encapsulate the average number of oil droplets per encapsulate particle can vary widely, e.g. from 1.0 to 10⁹. Preferably, the encapsulate contains 1.0 to 10⁶ of oil droplets per encapsulate particle.

In a particularly preferred embodiment, the protein-based oil encapsulate is prepared through a process that ensures that the oil droplets are completely enveloped by the protein-based matrix. This may, for instance, be achieved by employing a method in which an aqueous suspension comprising a dispersed oil phase and activated protein aggregates is cross-linked after the protein aggregates have been allowed to form a sizeable layer around the oil droplets. In accordance with this embodiment, the surface oil content of the encapsulate is less than 10%, more preferably less than 5% and most preferably less than 2%. The surface oil content can suitably be determined by adding 100 mL carbontetrachloride to 10 gram encapsulate at room temperature and allowing 15 minutes of contact time. Next, the mixture is filtered using 502 Schleicher & Schuell filter. 50 mL filtrate is weighed and subsequently the carbontetrachloride is evaporated by drying. After drying the dry amount is weighed again. Form these measurements the amount of surface oil can be determined.

The encapsulate of the present invention advantageously is substantially water-free. Typically, the encapsulate contains less than 20 wt. % of water. Even more preferably the water content does not exceed 10 wt. %.

The present invention also encompasses an embodiment in which the encapsulate comprising the oil droplets and the protein-based matrix is coated with one or more protective layers. The use of such coating layers may even further improve the oxidative stability of the present encapsulate. Such coatings may also be applied in order to make the encapsulate less sensitive to conditions of shear. According to a particularly preferred embodiment the present encapsulate contains at least one coating layer that contains at least 60 wt. % of one or more components selected from the group consisting of lipids (including waxes and low PUFA fats), polyols (such as: glycerol, xylitol), menthol, glyceryl triacetate, di-(2-ethylhexyl) adipate, plasticizers (such as glycerol, glyceryl triacetate and/or di-(2-ethylhexyl) adipate, or others), or mixtures of two or more plasticizers; sugars (such as for example: lactose, sucrose, glucose, galactose), hydrocolloids (such as for example: gum Arabic, alginate, pectin, starch, xanthan gum, carrageenan, guar gum, locust bean gum, tara gum, gellan gum), salts (such as for example: sodium salts, calcium salts, potassium salts, enzymes (such as for example: proteases, peptidases, oxidases, hydrolases, esterases, lyases), cross-linkers (such as for example: tannins, transglutaminase, formaldehyde, glutaraldehyde), antioxidants, and additional layers of activated protein aggregates.

The present invention also provides a method of producing an encapsulate as defined herein before, said method comprising:
preparing an emulsion comprising a continuous aqueous phase containing activated protein aggregates and a dispersed oil phase, said preparation comprising:
   a. providing an aqueous solution of a protein that is capable of forming disulfide cross-links;
   b. submitting said aqueous solution to a protein activation treatment to produce an aqueous suspension of activated protein aggregates, said activated aggregates having a reactivity of at least 5.0 μmol thiol groups per gram protein as determined in the Ellman's assay;
   c. wherein the aqueous solution contains a dispersed phase of oil or wherein the oil is dispersed throughout the suspension of activated protein aggregates;
      followed by:

allowing the activated protein aggregates to form a layer at the interface of the dispersed oil phase and the aqueous phase; and

producing microcapsules by forming disulfide cross-links between the activated protein aggregates;

or by:

dispensing said aqueous suspension in a gas or a water-immiscible liquid to produce droplets having a volume weighted average diameter in the range of 0.1-500 μm, preferably in the range of 0.5-250 μm; and

forming disulfide cross-links between the activated protein aggregates within the droplets.

It should be understood that the aqueous solution of protein that is capable of forming disulfide cross-links can also contain non-dissolved protein and other non-dissolved components.

In the present method, the aqueous protein solution (which optionally further comprises additives) is submitted to a protein activation treatment. The nature of this treatment is not essential, as long as the protein becomes sufficiently activated for further use. Thus, although the activation treatment is preferably a heat treatment, other methods may also be suitable for achieving the same degree of protein activation, such as application of high pressure, shear forces, etc. Examples of suitable methods for achieving adequate protein reactivity are heat treatment, microwave treatment, high pressure, shear, unfolding with urea, and combinations thereof. The skilled person can easily determine whether the treatment results in sufficiently activated (reactive) protein aggregates.

When heat treatment is used to activate the proteins, the temperature and time required for obtaining the minimum reactivity depends on the types of protein used and other conditions, such as applied shear, pH of the solution, salts, etc. For example, heat treatment of a solution of 9% wt. whey proteins (BiPRO™; Davisco, USA) in demineralized water for 30 minutes holding time at 90° C. in a water bath without stirring resulted in a reactivity of more than 15 μmol per gram of protein.

The activation treatment preferably comprises heating the aqueous solution to a temperature of at least 60° C. and less than 200° C. for at least a period of time equal to t, which period of heating t is governed by the following formula: t=(500/(T−59))−4

wherein: t=duration of heating (in seconds) and

T=heating temperature (in ° C.).

More preferably the heating conditions complied are governed by the following formula:

t=(90000/(T−59))−900.

For any given type of protein and protein-comprising solution, a skilled person can easily determine conditions which are suitable for obtaining the minimum reactivity required by varying these conditions and measuring the reactivity of the protein aggregates obtained after treatment. Whatever treatment is used for activation, the treatment should be sufficient to result in protein aggregates having a reactivity of at least 5 μmol thiol groups per gram of protein. Preferably, the reactivity achieved is at least 10 μmol/g, more preferably at least 15 μmol/g, even more preferably at least 20 μmol/g and most preferably at least 25 μmol/g.

Reactivity is required to enable covalent cross-linking of the protein aggregates. The reactivity is defined as the number of reactive thiol groups per gram of protein. Exposure of reactive thiol groups, which leads to their reactivity, can be achieved by e.g. heat-treatment.

The aforementioned reactivity can suitably be determined at pH 7 according to the Ellman's assay (Ellman, 1959 vide supra). In this assay the number of thiol groups is determined using ε(412 nm)=13,600 M⁻¹ cm⁻¹ for 2-nitro-5-mercaptobenzoic acid (DTNB) and expressed as the amount of thiol groups (μmol) per gram of protein (aggregates). The absorbance is measured at 20-25° C. The value after 30 minutes of incubation with DTNB is taken to calculate the reactivity. The reactivity is measured by determining the concentration of thiol groups (in mM) in a 2 wt. % protein solution.

A convenient way to perform the Ellman's assay is described in Alting et al. (Formation of disulphide bonds in acid-induced gel of preheated whey protein isolate. J. Agric. Food Chem. 48 (2000) 5001-5007). Typically, 0.25 ml of a 1 mg/ml DTNB solution in 50 mM imidazol-buffer pH 7 (pH adjusted with HCl), 0.2 mL protein solution (2 wt % protein solution) and 2.55 ml imidazol-buffer pH 7 are mixed. The assay is preferably performed in the absence of detergents such as urea or SDS.

In the present method the aqueous phase of the emulsion containing the activated protein aggregates typically contains from 0.1-25 wt. % of the protein capable of forming disulfide links. More preferably, said emulsion contains from 0.5-15 wt. % of the protein capable of forming disulfide links. The amount of oil contained in the emulsion typically lies within the range of 5-60 wt. %, more preferably in the range of 10-45 wt. %.

The activated protein aggregates in the emulsion preferably have a volume weighted average diameter in the range of 1-1000 nanometers, more preferably in the range of 2-250 nanometers, even more preferably in the range of 2-100 nanometers.

In the present method one or more (food-grade) additives may be added to the protein aggregates, either before the activation treatment and/or after the activation treatment, but prior to the cross-linking treatment. Preferably the additives are not reactive towards the activated protein aggregates, e.g. the additives do not react with free thiol groups as this would interfere with the cross-linking of the protein. The exception to this concerns cross-linkers which will assist in cross-linking the activated protein aggregates.

According to one embodiment of the present method, cross-linking of the activated protein aggregates is achieved by a “wet procedure” comprising the steps of:

allowing the activated protein aggregates to form a layer at the interface of the dispersed oil phase and the aqueous phase; and

producing microcapsules by forming disulfide cross-links between the activated protein aggregates.

In this wet procedure, microcapsules are formed in situ in the oil-in-water emulsion. The resulting dispersion of microcapsules can be employed as such in the preparation of e.g. a foodstuff, a beverage, a nutritional supplement or animal feed. Alternatively, the dispersion may be dried to yield a dry encapsulate. Naturally, it is also feasibly to produce an emulsion containing a high concentration of microcapsules by removing a fraction of the water contained in the emulsion, preferably after the cross-linking

In another embodiment of the present method, cross-linking of the activated protein aggregates is achieved by a “dry procedure” comprising the steps of:

dispensing said aqueous suspension in a gas to produce droplets having a volume weighted average diameter in the range of 0.1-500 μm, preferably in the range of 0.5-250 μm; and

forming disulfide cross-links between the activated protein aggregates within the droplets.

Preferably, in this particular embodiment, the formation of the disulfide cross-links is brought about by subjecting the dispensed droplets to heat. A convenient way of subjecting the dispensed droplets to a heat treatment is to dispense the aqueous suspension into a hot gas and/or by spraying the aqueous suspension onto hot core particles.

The aforementioned wet procedure for producing an encapsulate according to the present invention yields an oil-in-water emulsion that can suitably be applied in foodstuffs, beverages, nutritional supplements or animal feed. The use of the present encapsulate in the form of an emulsion instead of a dry powder, offers the advantage that a drying step can be avoided. This is not only advantageous from an economic perspective but also avoids possible oxidative degradation of the oil during the drying operation.

Hence, another aspect of the present invention relates to an oil-in-water emulsion comprising 3-95 wt. % of a continuous aqueous phase and 5-97 wt. % of a dispersed oil phase containing at least 3 wt. %, preferably at least 10 wt. % of polyunsaturated fatty acids by weight of oil, the oil droplets of said dispersed oil phase having a volume weighted average diameter within the range of 0.1-100 μm, wherein the oil droplets are enclosed by a protein-based layer containing at least 10 wt. % of a protein that has been cross-linked by means disulfide cross-links, and wherein at least 50% of this cross-linked protein dissolves when dithiothreitol (DTT) is incorporated in the aqueous phase in a concentration of 2% by weight of water.

According to a preferred embodiment, the present emulsion contains at least 10 wt %, most preferably at least 20 wt. % of a dispersed oil phase.

The amount of cross-linked protein in the present emulsion typically is within the range of 0.1-25% by weight of the continuous aqueous phase, more preferably within the range of 0.5-15% by weight of the continuous aqueous phase.

In the present emulsion the dispersed oil droplets can be encapsulated effectively by means of a relatively thin protein-based layer. Hence, especially in case the oil droplets are relatively large, the ratio of oil to protein-based layer can be quite high. Typically, in the present emulsion the oil in the oil droplets and the protein in the protein-based layer are contained in the emulsion in a weight ratio oil:protein of 1:8 to 200:1, preferably in a weight ratio oil:protein of 1:4 to 10:1.

Another aspect of the present invention relates to a foodstuff, a beverage, a nutritional supplement or animal feed containing from 0.3-80 wt. % of an encapsulate as defined herein before or from 0.5-98 wt. % of an oil-in-water emulsion as defined herein before.

Yet another aspect of the invention relates to a method of preparing a foodstuff, a beverage, a nutritional supplement or animal feed, said method comprising incorporating from 0.3-80 wt. % of an encapsulate according to the present invention or from 0.5-98 wt. % of an oil-in-water emulsion according to the present invention.

The invention is further illustrated by means of the following examples.

### EXAMPLES

### Example 1

### Preparation of Spray-Dried Fish Oil Capsules Using Activated Whey Protein Aggregates

Protein solutions were prepared by mixing 54 g of whey protein isolate (BiPRO™; Davisco, USA) in 546 g of demineralized water at room temperature (stirred for 2 h).

Reactive protein aggregates were prepared by heating the whey protein isolate solution at 90° C. during 30 min in a water bath. The solution was further cooled down in ice and then brought to room temperature.

The reactivity of the particles was determined using the DTNB-method as described before. The reactivity was about 20 μmol thiol groups per gram protein.

A pre-emulsion was prepared by mixing 128 g of demineralized water and 400 g of a solution of 9% of reactive protein aggregates and 72 g of fish oil (batch 116k1837 Sigma Aldrich) using an Ultra-turrax (2 min at power 9.5). The mixture was then homogenized using a two-stage high pressure homogenizer (Model NS 1001L-PANDA, Niro Soavia S.P.A., Italy; flow 10 L/h) (400/40 bar).

Prior to spray drying, 77.52 g of maltodextrin was added to 430.65 g of emulsion. The mixture was slowly stirred. The mixture was then diluted to reach a dry matter content of 25% w/w.

In the next step the emulsion was spray-dried using a Buchi lab-scale spray-dryer (inlet temperature 160° C., outlet temperature 91° C.). By spray-drying a powder was obtained (Batch 1).

### Comparative Example A

### Preparation of Spray-Dried Fish Oil Capsules Using Native Whey Protein Isolate

Protein solutions were prepared by mixing 54 g of whey protein isolate (BiPRO™; Davisco, USA) in 546 g of demineralized water at room temperature (stirred for 2 h).

The reactivity of the native whey protein isolate was determined using the DTNB-method as described before. The reactivity was about 1.8 μmol thiol groups per gram protein.

A pre-emulsion was prepared by mixing 128 g of demineralized water and 400 g of a solution of 9% of reactive protein aggregates and 72 g of fish oil (batch 116k1837 Sigma Aldrich) using an Ultra-turrax (2 min at power 9.5). The mixture was then homogenized using a two-stage high pressure homogenizer (Model NS 1001L-PANDA, Niro Soavia S.P.A., Italy; flow 10 L/h) (400/40 bar).

Prior to spray drying, 81.37 g of maltodextrin was added to 452.07 g of emulsion. The mixture was slowly stirred. The mixture was then diluted to reach a dry matter content of 25% w/w.

In the next step the emulsion was spray-dried using a Buchi lab-scale spray-dryer (inlet temperature 160° C., outlet temperature 91° C.). By spray-drying a powder was obtained (Batch 2).

### Example 2

### Solubility Assay of Spray-Dried Fish Oil Capsules

The solubility of the encapsulation matrix of the fish oil encapsulates of Examples 1 and A was tested at pH 7 at 20° C. in distilled water and in an aqueous solution of 2 wt. % dithiothreitol (DTT). To this end, 75 mg of the encapsulate was dispersed in 50 ml distilled water and 75 mg of the encapsulate was dispersed in 50 ml of an aqueous solution of 2 wt. % dithiothreitol (DTT). The capsules were gently stirred overnight. The supernatant was filtered and the soluble proteins were quantified by spectrophotometer reading at 280 nm.

As shown in Table 1, the capsules prepared with reactive protein aggregates (Example 1) were almost insoluble in water at pH 7, whereas they were soluble in the aqueous solution of 2 wt. % dithiothreitol (DTT). The capsules prepared with native whey protein isolate (Example A) were soluble in both water of pH 7 and an aqueous solution of 2 wt. % dithiothreitol (DTT).

TABLE 1
Solubility of capsules

| | Solubility (%) | Solubility (%) |
|---|---|---|
| Capsules | at pH 7 | in 2 wt. % DTT |
| Example 1 | 18 | 100 |
| Example A | 100 | 100 |

### Example 3

### Measurement of Oxidation Products of Encapsulated Fish Oil in a Dry Environment

The fish oil encapsulates of Examples 1 and A were stored in open containers at ambient conditions during 5 weeks. An open container containing the fish oil used for the preparation of the capsules was used a reference and stored under the same conditions. The concentrations of some typical fat oxidation products of fish oil were measured in the capsules and the free fish oil sample using gas chromatography. The amount of the oxidation products measured for the capsules were expressed as the percentage of the amount of oxidation products measured for the free fish oil (Table 2 and Table 3).

As shown in Table 2 and Table 3, the capsules prepared with reactive protein aggregates (Example 1) were more resistant against oxidation compared to the capsules prepared with native whey proteins (Example A).

TABLE 2
Relative amount of fish oil oxidation products after 4 weeks of ambient
storage.

| | Relative amount | Relative amount |
|---|---|---|
| | (%) for | (%) for |
| Oxidation product | Example 1 | Example A |
| 2,3-pentanedione | 39 | 72 |
| 3,5-octadien-2-one | 52 | 58 |
| 3,5-undecadien-2-one | 65 | 70 |
| 2,4-heptadienal | 32 | 40 |

TABLE 3
Relative amount of fish oil oxidation products after 5 weeks of ambient
storage.

| | Relative amount | Relative amount |
|---|---|---|
| | (%) for | (%) for |
| Oxidation product | Example 1 | Example A |
| 2,3-pentanedione | 5 | 4 |
| 3,5-octadien-2-one | 10 | 13 |
| 3,5-undecadien-2-one | 32 | 39 |
| 2,4-heptadienal | 12 | 12 |

### Example 4

### Preparation of an Aqueous Suspension of Fish Oil Capsules with Activated Protein Aggregates

Protein solution was prepared by mixing 54 g of whey protein isolate (Bipro; Davisco, USA) in 546 g of demineralized water at room temperature (stirred for 2 h).

Reactive protein aggregates were prepared by heating the whey protein isolate solution at 68.5° C. during 2 hours in a water bath. The solution was further cooled down in ice and then brought to room temperature. The reactivity of the particles was determined using the DTNB-method as described before. The reactivity was about 17 μmol thiol groups per gram protein.

A pre-emulsion was prepared by mixing 128 g of demineralized water and 400 g of a solution of 9% of reactive protein aggregates and 72 g of fish oil (batch 116k1837 Sigma Aldrich) using an Ultra-turrax (2 min at power 9.5). The mixture was then homogenized using a two-stage high pressure homogenizer (Model NS 1001L-PANDA, Niro Soavia S.P.A., Italy; flow 10 L/h) (400/40 bar). The suspension of fish oil capsules with activated protein aggregates was subsequently heated for at 90° C. during 30 minutes in a water bath. The emulsion was further cooled down in ice and then brought to room temperature.

### Example 5

### Measurement of Oxidation Products of the Aqueous Suspension of Fish Oil Capsules

The aqueous suspension of fish oil capsules of Example 4 was stored in an open container at ambient conditions during 5 weeks. An open container containing the fish oil used for the preparation of the suspension of the fish oil capsules was used a reference and stored on the conditions described for the capsules. The amounts of oxidation products of fish oil were measured in the capsules and the free fish oil sample using gas chromatography. The amount of the oxidation products measured for the aqueous suspension of fish oil capsules were expressed as the percentage of the amount of oxidation products measured for the free fish oil (Table 4).

As shown in Table 4, the aqueous solution of fish oil capsules prepared with reactive protein aggregates was much more resistant against oxidation compared to the unprotected fish oil.

TABLE 4
Relative amount of fish oil oxidation products measured after
5 weeks of ambient storage.

| | Relative amount (%) for the |
|---|---|
| | aqueous suspension of fish |
| Oxidation product | oil capsules |
| 2,3-pentanedione | 6 |
| 3,5-octadien-2-one | 17 |
| 3,5-undecadien-2-one | 15 |
| 2,4-heptadienal | 4 |
| hexanal | 15 |
| trans-2-octenal | 14 |
| decatrienal | 5 |

1-12. (canceled)

13. An encapsulate comprising a protein-based encapsulation matrix which envelops one or more oil droplets, the oil droplets comprising at least 3 wt. % of polyunsaturated fatty acids by weight of oil, and the encapsulate having a mass weighted average diameter in the range of 0.5-5000 μm,
wherein the protein-based encapsulation matrix comprises at least 10 wt. % of a protein cross-linked by disulfide bonds selected from whey proteins, egg proteins, soy proteins, lupine proteins, rice proteins, pea proteins, wheat proteins and combinations thereof; and wherein:
(i) less than 40 wt. % of protein comprising the protein-based matrix is dissolved when 75 mg of the encapsulate is dispersed in 50 ml distilled water having a temperature of 5° C. at a pH within the range of 3.0-7.0; and
(ii) the weight percentage of the protein that can be dissolved is at least a factor 1.3 higher when in the procedure under (i) the distilled water is replaced by an aqueous solution of 2 wt. % dithiothreitol (DTT).

14. The encapsulate according to claim 13, wherein the oil in the oil droplets and the protein in the protein-based encapsulation matrix are contained in the encapsulate in a weight ratio oil:protein of 1:8 to 200:1.

15. The encapsulate according to claim 13, wherein the oil droplets comprise at least 3 wt. % of one or more polyunsaturated fatty acids selected from the group consisting of C₁₈-C₂₄ ω3-fatty acids, C₁₈-C₂₄ ω6-fatty acids and combinations thereof.

16. The encapsulate according to claim 13, wherein the one or more polyunsaturated fatty acids are selected from the group consisting of docosahexaenoic acid (DHA), eicosapentaenoic acid (EPA), conjugated linoleic acid (CLA), arachidonic acid, gamma-linoleic acid, and combinations thereof.

17. The encapsulate according to claim 13, wherein the protein cross-linked by disulfide bonds comprises at least three cystein residues per molecule.

18. The encapsulate according to claim 13, wherein the protein cross-linked by disulfide bonds is selected from the group consisting of whey proteins, egg proteins, soy proteins and combinations thereof.

19. The encapsulate according to claim 13, wherein the protein cross-linked by disulfide bonds exhibits a number weighted average degree of polymerisation of at least 500.

20. An oil-in-water emulsion comprising:
(a) 3-95 wt. % of a continuous aqueous phase and
(b) 5-97 wt. % of a dispersed oil phase comprising at least 3 wt. % of polyunsaturated fatty acids by weight of oil, the oil phase comprising droplets having a volume weighted average diameter within the range of 0.1-100 μm,
wherein the oil droplets are enclosed by a protein-based layer comprising at least 10 wt. % of a protein cross-linked by disulfide bonds selected from whey proteins, egg proteins, soy proteins, lupine proteins, rice proteins, pea proteins, wheat proteins and combinations thereof, and wherein:
(ii) less than 40 wt. % of protein comprising the protein-based matrix is dissolved when 75 mg of the encapsulate is dispersed in 50 ml distilled water having a temperature of 5° C. at a pH within the range of 3.0-7.0 and
(ii) at least 50% of protein cross-linked by disulfide bonds dissolves when dithiothreitol (DTT) is incorporated in the aqueous phase in a concentration of 2% by weight of water.

21. The oil-in-water emulsion according to claim 20, wherein the oil in the oil droplets and the protein in the protein-based layer are contained in the emulsion in a weight ratio oil:protein of 1:8 to 200:1.

22. A method of producing an encapsulate, comprising:
(a) providing an aqueous solution of a protein selected from whey proteins, egg proteins, soy proteins, lupine proteins, rice proteins, pea proteins, wheat proteins and combinations thereof;
(b) submitting said aqueous solution to a protein activation treatment to produce an aqueous suspension of activated protein aggregates having a reactivity of at least 10 μmol thiol groups per gram protein as determined in the Ellman's assay, wherein the aqueous solution contains a dispersed phase of oil or wherein the oil is dispersed throughout the suspension of activated protein aggregates;
(c) dispensing said emulsion in a gas or a water-immiscible liquid to produce droplets having a volume weighted average diameter in the range of 0.1-500 μm; and,
(d) crosslinking disulfides between the activated protein aggregates within the droplets.

23. A method of producing an oil-in-water emulsion, comprising:
(a) providing an aqueous solution of a protein selected from whey proteins, egg proteins, soy proteins, lupine proteins, rice proteins, pea proteins, wheat proteins and combinations thereof;
(b) submitting said aqueous solution to a protein activation treatment to produce an aqueous suspension of activated protein aggregates, said activated aggregates having a reactivity of at least 10 μmol thiol groups per gram protein as determined in the Ellman's assay, wherein the aqueous solution comprises a dispersed phase of oil or wherein the oil is dispersed throughout the suspension of activated protein aggregates;
(c) allowing the activated protein aggregates to form a layer at the interface of the dispersed oil phase and the aqueous phase; and
(d) producing the microcapsules by forming disulfide cross-links between the activated protein aggregates.

24. A foodstuff, a beverage, a nutritional supplement or animal feed comprising from 0.3-80 wt. % of an encapsulate according to claim 13.

25. A foodstuff, a beverage, a nutritional supplement or animal feed comprising from 0.5-98 wt. % of an oil-in-water emulsion according to claim 20.

26. A method of preparing a foodstuff, a beverage, a nutritional supplement or animal feed, said method comprising incorporating therein from 0.3-80 wt. % of an encapsulate according to claim 13.

27. A method of preparing a foodstuff, a beverage, a nutritional supplement or animal feed, said method comprising incorporating therein from 0.5-98 wt. % of an oil-in-water emulsion according to claim 20.
